(19) United States
(12) Patent Application Publication
(10) Pub. No.: US 2015/0381941 A1
(43) Pub. Date: Dec. 31, 2015

(54) Modular Connected Headrest

(71) Applicant: Mobile Data Holdings Limited, Inc., Sterling Heights, MI (US)

(72) Inventors: D Scott Watkins, Huntington Woods, MI (US); John Lamont, Mebane, NC (US)

(73) Assignee: MOBILE DATA HOLDINGS LIMITED, INC., Sterling Heights, MI (US)

(21) Appl. No.: 14/755,764

(22) Filed: Jun. 30, 2015

Related U.S. Application Data
(60) Provisional application No. 62/019,166, filed on Jun. 30, 2014.

(51) Int. Cl. H04N 7/18; B60N 2/58; B60N 2/48; H04N 5/225

(52) U.S. Cl. CPC H04N 7/181; H04N 5/225; B60N 2/58; B60N 2/4876

(57) ABSTRACT

A motor vehicle usage tracking system for monitoring, evaluating, and reporting on operations of motor vehicles each having a modular connected headrest with an imaging device for imaging in a viewpoint from a driver's seating position and communicating with a data bus in the motor vehicle for the operational data correlated with the imaging and communicated to the servicer having an analyzer configure for evaluating and reporting on motor vehicle operations. An aftermarket sleeve is disclosed for retro-fit installation of the motor vehicle tracking device.

The present application claims benefit of U.S. Provisional Patent Application Ser. No. 62/019,166, filed Jun. 30, 2014, which is incorporated herein by reference in its entirety.

### TECHNICAL FIELD

The present invention relates to headrests for seats in motor vehicle. More particularly, the present invention relates to apparatus and methods for driver point of view imaging during operation of motor vehicles with headrests for seats populated for imaging, correlating vehicle operational data and communicating correlated images and operational data to a servicer for monitoring, evaluation and reporting.

### BACKGROUND OF THE INVENTION

While video imaging devices have been available for use in motor vehicles to provide a reasonable approximation of the driver's viewpoint during operation of the motor vehicle, there are drawbacks to the use of such. Installation and integration of current apparatus that provides video/audio imaging and interconnections with vehicle performance monitoring devices is difficult for new vehicle production, and particularly for aftermarket retrofit into a motor vehicle.

The difficulties arise from the need to maintain the cockpit safety constructs for motor vehicle driver and passenger occupancy and operation yet provide effective capturing of the vehicle interior, vehicle operational data such as is available for dashboard display, and driver local and remote distant views. Equipment installation must meet interior secure mounting requirements for retention during accident circumstances to avoid or prevent occupant body or head injury from such equipment. Prior spaces in the motor vehicle are less available in recent production vehicles that in prior productions. This is due to the installation of active safety systems within the frontal strike zones of motor vehicles, which systems occupy previously available space, such as in front of the rear view mirror. Placement of imaging device or camera becomes structurally difficult and tends to be off-center such that a second or multiple imaging devices are necessary to provide reasonable viewpoint imaging. In addition to labor and installation time, there is also the issue of creating appropriate wiring harnesses necessary to achieve the important imaging and data collection features for appropriate recordation of vehicle operation. This is includes interfaces with vehicle information systems, such as OBDII or J1939 information systems. In addition to the structural positioning and securing requirements and the information collection functions, the real-time generation and collection of vehicle operational data requires recording and communicating of data to appropriate information usage facilities. This involves recording mediums with attendant chain of custody issues and/or communication of data through networks that require appropriate connectivity and transmission apparatus including communicators, connectors and cabling, and antenna links to networks and communication systems.

Further, the recent rapid adoption of global positioning systems (GPS) location and tracking, text messaging, and electronic mail, particularly via smart mobile communication devices, has not translated into improvements in the safety of the driver and passenger occupants. At least two issues—driver distraction and loss of sight—may be attributed to accidents. The issues, while independent, may also be connected and contributory. The electronics available to a driver include radio systems (both conventional and satellite), CD, GPS, network interconnectivity, mobile cellular telephone, and other, may lead to driver distraction in operation of such devices. Indeed, many states restrict driver use of cellular phones during motor vehicle operations. Repositioning information into a “far view” presentation window or to a heads-up display has been costly and is generally limited as to the scope of information that is displayable (such as limited to motor vehicle speed). The use of a heads-up display may beneficially require voice activation in order for the driver to keep both hands on the steering wheel and maintain constant view of roadway.

There are challenges in deploying video cameras and data access and information systems as standardized equipment packages due to the variables and designs involved with the interior of a motor vehicle. The field of view problems also arises in obtaining not just the driver's view but those of other occupants, and the suitable positioning of imaging devices to collect such viewpoints. The lack of uniform structures across manufacturer platforms for motor vehicles (and multi-manufacturer platforms), presents implementation issues but the present need may lead to further joint agreements on standardized structures. Installation presents difficulties (both OEM and aftermarket retro-fit) particularly utilizing cables for power, control, and data communication, as well as device and equipment housings, secure mountings, and placement. Around these issues also revolves the attendant safety requirements for motor vehicle occupants, as well as installation labor and time.

Accordingly, there is a need in the motor vehicle art for an improved readily installed imaging video/audio/data/connecting apparatus and method for real-time monitoring of motor vehicle operations. It is to such that the present invention is directed.

### BRIEF SUMMARY OF THE INVENTION

The present invention meets the need in the art by providing a modular camera recording connecting headrest available in embodiments for original equipment manufacturer installation in production motor vehicles and in embodiments configured for aftermarket retro-fit installation in existing motor vehicles. In accordance with the present invention, the headrest device (either OEM seating headrest structure or shape-comparable conforming sleeve, as discussed below) incorporates system components for the imaging, data collection, and data communication functions, with optionally incorporated devices, connectors, cabling, and equipment therefore. The headrest houses the imaging devices, cameras, recorders, data interface devices for vehicle information systems, wiring harnesses, communicators, network connection devices and network communications devices, and antennas. The modular camera recording connecting headrest comprises in one embodiment an OEM manufactured and installed headrest for a motor vehicle and in yet another embodiment a sleeve for aftermarket retro-fit installation in a motor vehicle, thereby providing a simple, quickly installed safe modular imaging and recording system. In a further embodiment, the system configures for using wireless connectivity to networks for operation within the motor vehicle such as for connection to ODBII devices and/or cellular by tethering to cell phones, mobile computer devices, personal data assistant devices, tablets, or other computer-based communications modules that may eliminate additional antennas. Connectivity may also be near but outside the motor vehicle, such as a local data communications station, for example, for tethering to a collection system for secure access to motor vehicle and engine operation information. Further, the headrest may also include either attached or embedded antenna system to wirelessly connect over great range, wi-fi or near field network communications. Other features include narrow cables and connectors, such a flat band wiring harnesses and connectors, wired cables and connectors, power supply cables, and the like, suitable use within the headrests, for example, for no-exposure passage through conventional narrow tubular headrest support posts. The system may use vehicle specific connectors to power supply and/or vehicle information systems, or may apply generic connectors for appropriate use with a range of motor vehicles (such as a common manufacturer vehicle platforms or multiple-manufacturer cross-platform industry standard comparable motor vehicles). The modular camera recording connecting headrest in accordance with the present invention provides costs savings, reduced cabling and connectors, yet provide a safe attractive apparatus for imaging and memorializing motor vehicle operational information appropriate for government, police, commercial business and personal applications with mass market appeal.

More particularly described, the present invention meets the need in the art by providing a motor vehicle usage tracking system, comprising a servicer configured for monitoring operations of a plurality of motor vehicles that are each equipped with a data bus that periodically receives one or more signals representative of motor vehicle operational data, the data bus including a timer for associating the motor vehicle operational data with a time of occurrence and a bi-directional communications device, for tracking usage and situational circumstances of the motor vehicle operations, evaluating motor vehicle operations, and reporting on motor vehicle operations. A communications device operatively engaged to a communications network and to the servicer communicates between the servicer and a respective communications device of the plurality of motor vehicles. A geophysical locating device for determining periodically a location of the geophysical locating device and an associated time thereof is configured for communicating the determined location and associated time to the data bus of the motor vehicle. A plurality of modular headrests, each for being installed in a respective one of the plurality of motor vehicles, contains at least one imaging device mounted therein for being disposed between an upper edge of a driver's seat and an interior surface of a roof of the motor vehicle proximate and lateral of a longitudinal axis of the motor vehicle for imaging in a selected direction that is substantially in alignment with a proximate oriented viewpoint from a driver's seating position within the motor vehicle to generate at least an image proximate the motor vehicle at a time of operation of the imaging device, and a controller for connecting to the data bus of the motor vehicle for receiving the operational data thereof and the associated time and configured for correlating the imaging with the motor vehicle operational information. The respective communications device of the motor vehicle for communicating the periodic location and time and correlated operational data to the servicer, and upon demand, communicating at least a portion of the imaging generated by the imaging device.

In another aspect, the present invention meets the need in the art with an aftermarket motor vehicle usage tracking device, comprising a sleeve having a back, a front, and opposing sides open at a first end, with a housing extending from one of the opposing sides, and the sleeve sized for aftermarket retro-fit installation by being slidably received on a headrest of a motor vehicle. At least one imaging device mounts in a wall of the housing, to dispose the imaging device between an upper edge of a driver's seat and an interior surface of a roof of the motor vehicle proximate and lateral of a longitudinal axis of the motor vehicle for imaging in a selected direction that is substantially in alignment with a proximate oriented viewpoint from a driver's seating position within the motor vehicle to generate at least an image proximate the motor vehicle at a time of operation of the imaging device. A recorder stores an electronic representation of the imaging by the imaging device. A communications device communicates the stored electronic representation of the imaging to a servicer configured for monitoring operations of a plurality of motor vehicles.

Objects, advantages, and features of the present invention will be readily apparent upon a reading of the following detailed description in conjunction with the drawings and appended claims.

### BRIEF DESCRIPTION OF THE DRAWINGS

FIG. 1 illustrates in schematic view a modular connected headrest for a motor vehicle operatively engaged through a network with a service center which images, correlates motor vehicle information, and communicates operational information of the motor vehicle for monitoring and evaluation thereof.

FIG. 2 illustrates in front view a first embodiment of a modular connected headrest for a motor vehicle.

FIG. 3 illustrates in side view a second embodiment of the modular connected headrest for a motor vehicle illustrated in FIG. 2.

FIGS. 4A and 4B illustrate a second embodiment of a modular connected headrest for a motor vehicle.

FIG. 5 illustrates a system for comprehensive motor vehicle operation imaging and data correlation for a vehicle service center in accordance with the present invention.

### DETAILED DESCRIPTION

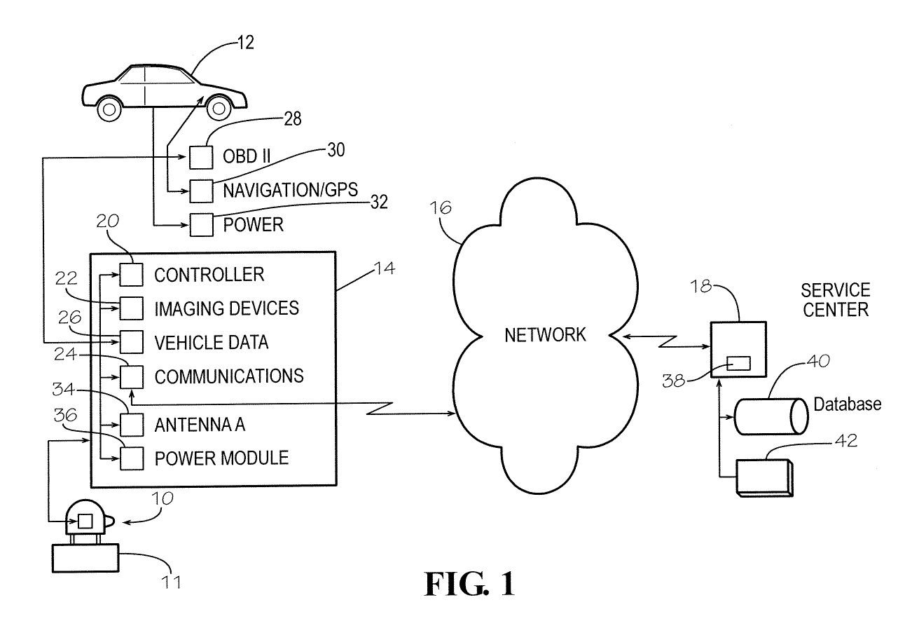

With reference to the drawings, in which like parts have like reference numerals, FIG. 1 illustrates in schematic view a modular connected headrest 10 for a seat (generally 11) in a motor vehicle 12 housing a system 14 operatively engaged through a network 16 with a service center 18, which system provides for monitoring motor vehicle operations, tracking usage and situational circumstances of motor vehicle operation, evaluating motor vehicle operation, and reporting on motor vehicle operation. The service center 18 provides motor vehicle tracking and reporting services, such as a commercial fleet operator, a motor vehicle manufacturer, a parent seeking to monitor and track motor vehicle usage by youthful drivers, government agency having a motor vehicle fleet, or other motor vehicle tracking provider/service. The modular connected headrest 10 houses the component devices of the system 14 for imaging of the motor vehicle and driver view point, correlating the imaging with motor vehicle operational information, and communicating the operational information of the motor vehicle for monitoring and evaluation by the service center. The system 14 includes a microprocessor 20, one or more imaging devices 22, and communications devices 24. The system 14 includes a vehicle data module 26. This may include connectors for engaging a data port in a motor vehicle information collecting system 28 such as the illustrated ODBII device. The system 10 may include as part of the vehicle data module 26 a global positioning system (GPS) device for location tracking information. Many production motor vehicles today include or feature navigation devices 30 that have global positioning system (GPS) equipment including dashboard display, information input devices (for example, touchscreen keyboard), and antenna. In such installations, the vehicle data module 26 connects to a controller for the on-board vehicle GPS system, rather than having duplicative equipment. The communications device 24 includes network connections that may include internet (etherport, Blue Tooth, or other networking device), or other antenna 34 that may connect wirelessly through communications protocols for wi-fi, near field network, cellular, or other non-direct wired connections, for communications through the network 16. The motor vehicle 12 provides a connection to a supply 32 of power for operating the system 14. The system 14 may include a supplemental battery backup 35 for continued operation of the system in the event of an accident that terminates the supply of power. A power module 36 connects through a wiring harness to the supply 32 of power from the motor vehicle 12. The service center 18 includes an analyzer 38 that using motor vehicle information memorialized for example in a database 40 to generate analysis reports 42 of motor vehicle operation in various circumstances. The analyzer 38 may be a microprocessor based computer or server configured for maintaining the database 40 and for interrogating the database for evaluation and reporting as to the operation of the motor vehicle 12.

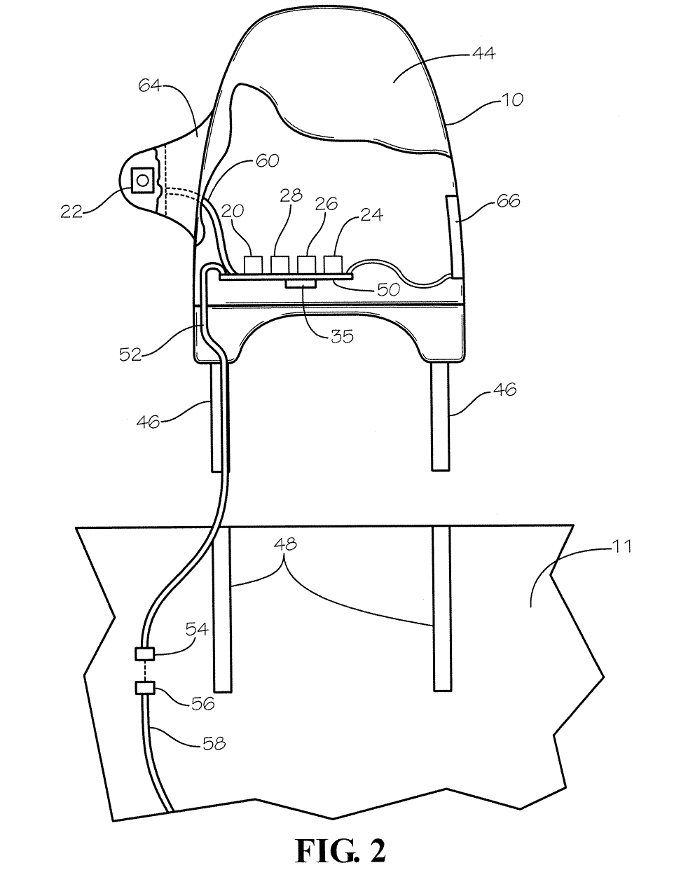

FIG. 2 illustrates in front view a first embodiment of the modular connected headrest 10 that engages the seat 11 of the motor vehicle 12. The headrest 10 may be a conventional OEM headrest modified to incorporate the structural components of the modular connected headrest in accordance with the present invention. The headrest 10 includes a head cushioning front face 44 and opposing back face with opposing sides. A pair of tubular members 46 extend from the headrest frame for being received in aligned support sleeves 48 mounted in the seat 11.

A board 50 mounts rigidly within the headrest 10. The various required and optional components attach to the board 50, including the power module 36 that distributes current to operate the components. A wiring harness 52 attaches the board 50 for supplying current to the power module 36. The wiring harness 52 extends through one of the tubular members 46 into the back of the seat 11. An opposing distal end of the wiring harness 52 detachably connects with a connector 54 to a mating connector 56 of a wiring harness generally 58 of the motor vehicle. A cable 60 for power and image/audio transfer connects to an imaging device 22 or camera such as CCD device. The imaging device 22 mounts in a laterally extending arm 64. Multiple imaging devices 22 may be used, such as forward view, rear view, lateral view, and 360° imaging. Further, the imaging device may be capable of infrared or normal optical wavelengths. In an alternate embodiment, the wiring harness 52 is external, disposed in a secure wiring race, or other damage resisting package. The wiring harness 52 may selectively connect to a separate power connector such as a power receptacle for powered equipment or a cigarette lighter. An antenna 66 configured for the communications module 24 mounts in the headrest 10 and connects to the communication module 24.

Disposing the imaging devices 22 proximate the head of the driver allows the images therefrom to be substantially that observed by the driver and proximate a longitudinal axis of the motor vehicle providing a view of the dashboard and the forward view close by and far view as may be observed by the driver. More particularly, the at least one imaging device 22 mounted in the modularly connected headrest 10 thereby is disposed between an upper edge of a driver's seat and an interior surface of a roof of the motor vehicle proximate and lateral of a longitudinal axis of the motor vehicle for imaging in a selected direction that is substantially in alignment with a proximate oriented viewpoint from a driver's seating position within the motor vehicle to generate at least an image proximate the motor vehicle at a time of operation of the imaging device. The images may be video or individual separate images imaged periodically. Further, the imaging may include, or exclusively, comprise signals representative of sounds received by a microphone as an exemplary sound imaging device.

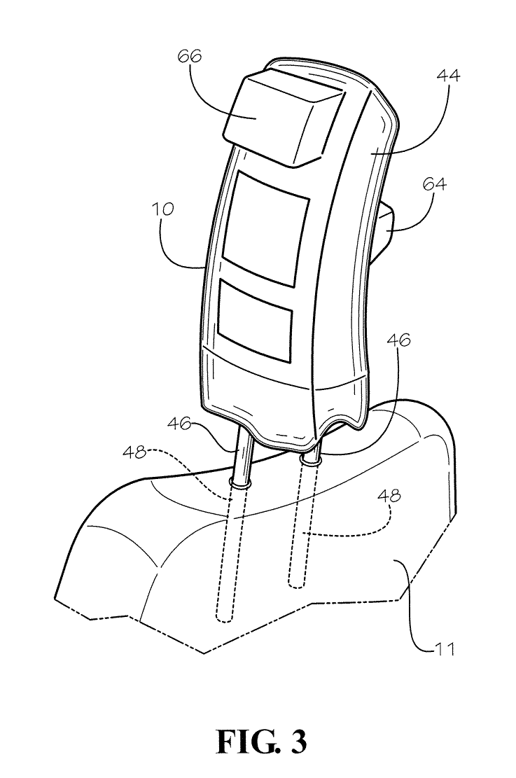

FIG. 3 illustrates in side view a second embodiment of the modular connected headrest 10 for the motor vehicle illustrated in FIG. 2. In this embodiment, the external antenna 66 mounts to a side of the headrest opposing the arm 64. The antenna 66 includes one or more global positioning satellite (GPS) antenna, cellular, wi-fi, or other communications transmitting and receiving apparatus for communicating signals for video, audio, digital image, vehicle operational data, and other sensed and imaged information relating to the motor vehicle, its operation in time periods, and the circumstantial surroundings such as roadway, traffic, weather conditions proximate the motor vehicle during operation.

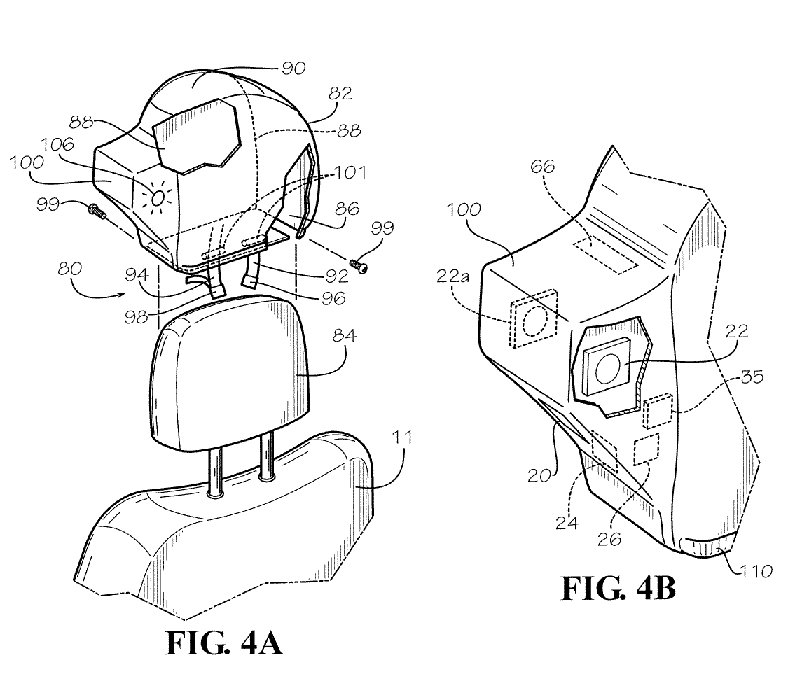

FIG. 4 illustrates in partial cut-away view a second embodiment of a modular connected headrest 80 for aftermarket retro-fit installation in a motor vehicle. The modular connected headrest 80 provides an open-ended sleeve 82, helmet, or tube that receives the conventional headrest 84 installed by the OEM manufacturer of the motor vehicle. The sleeve 82 in the illustrated embodiment assemble from a back 86 and two opposing sides 88, and enclosed within a sheet such as a fabric 90 or flexible covering material that defines a front surface. The back 86 and sides 88 are preferably a rigid sheet material such as a plastic sheet to provide structure for the sleeve 82 yet is light-weight and bendably flexible. A front strap 92 and a rear strap 94 attach to respective opposing edges of the sleeve 82. The straps 92, 94 include mating connectors 96, 98 respectively, for connecting the straps together underneath the bottom of the headrest 84. The straps, upon engagement of the connectors 96, 98, secure the sleeve 82 to the headrest 84. In an alternate embodiment, fasteners such as threaded screws 99 secure the sleeve to the headrest 84. Alternatively, a plurality clips engage a lower edge of the sleeve and extend underneath the headrest 84 for securing the sleeve to the headrest. As best illustrated in FIG. 4b, a housing 100 extends laterally on one side of the sleeve 82. The video imaging/audio device 22, communications device 24, vehicle data module 26 and antenna 66 mount in the housing 100. The illustrated embodiment includes both forward and rear viewing imaging devices 22.

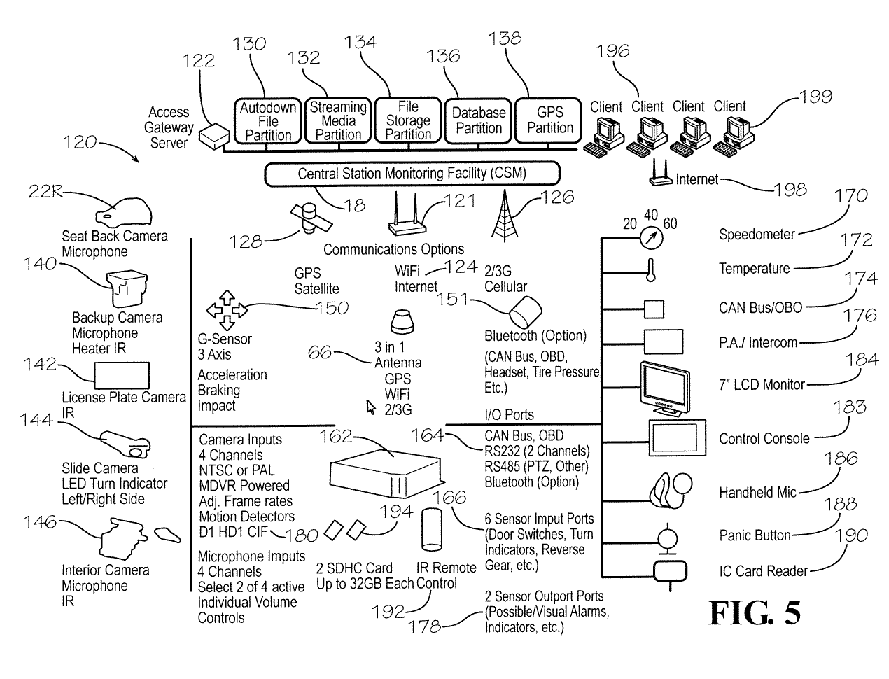

FIG. 5 illustrates a system 120 for comprehensive motor vehicle operation imaging and data correlation for the vehicle service center 18 in accordance with the present invention. The service center 18 includes an access gateway server 122 or microprocessor computer configured for network communications, such as internet 121, wi-fi 124, 2/3/4 or other cellular 126, as well as GPS signals 128. The server 122 includes a database and memory storage configured for autodown information 130, streaming media 132, with file storage 134, database 136, and GIS storage 138. The headrest 10 configures optionally with seat back imaging 22 and microphone, a backup camera 140 mounted exterior of the motor vehicle and that optionally includes a microphone, a heater, and infrared imaging. A license plate imager 142 or camera device may also be provided optionally, with a side camera 144 that optionally includes LED turn signal indicators (left or right side as installed and connected to the turn signal wiring harness of the motor vehicle). An interior camera 146 includes a microphone optionally with the imaging device. The motor vehicle may be equipped with vehicle operational and status sensors including a 3-axis G sensor device 150 for detecting acceleration, braking, and impact forces and loading. The three-in-one combined antenna 66 may be configured for one or more of GPS, WiFi, and cellular signals, with Bluetooth 151 optional for communications with vehicle equipment including CAN bus, ODT, OBDII, headrest 10, tire pressure sensors, and engine sensors if equipped.

A multiple digital video recorder device 162 includes camera inputs as well as I/O ports 164 (such as CAN bus, OBD or OBDII, RS232, RS485 (PTZ and/or other), and Bluetooth or other networked communications. Sensor inputs 166 include door switches, turn signal indicators, reverse, forward gear and the like. These inputs generally 168 include speed 170, temperature 172, motor vehicle status 174 available from CAN bus or OBD or equivalent, public address or intercom 1876. Output ports 178 include audio, visual, alarms, warning indicators and the like. Microphone inputs 180 include channeled inputs from the various installed optional microphones with optional volume control. The illustrated embodiment provides for four (4) imaging device (camera) inputs 182. The image or camera inputs 182 include NTSC or PAL signal configurations, MDVR powered adjustments, frame rates, motion detection, D1, HD1, and CIF. A control module 183 operates a data display screen 184 such as an LCD monitor (touch sensitive optionally). A handheld microphone 186 such as a Bluetooth wireless mic may be worn by the driver. A panic button 188 activates all available information devices, such as automatic recording during emergency situations. An IC card reader 190 communicates with the on-board controller. An IR remote control 192 provides system access and control when outwardly of the configured motor vehicle. The card reader 190 receives SDHC or equivalent cards 194. Clients 196 selectively access the service center 18, such as through network (internet) communications 198 connected to microprocessor computers 199. The clients include vehicle fleet operators (taxi, police, rental, transportation, delivery, and the like) as well as individual vehicle owners, sports car enthusiasts, motor vehicle owner/operators, motor vehicle manufacturers and equipment/component suppliers.

The system 120 is configured for audio/video and imaging recording, tracking accelerometer data, GPS (location), RF tag logs, event triggers (including speed, deceleration, alarm, air bag, and geofencing for tracking restricted or permissive locations), vehicle maintenance (mileage, oil pressure and quality, coolant temperature and life status, CAN bus, and OBDII data). The service center analysis is configured for driver scoring in comparison with predetermined established standards, including mileage (accumulated and trip-based), routing and re-routing, lane departure indication and tracking, trip recording, vehicle performance (such as fuel savings and costs and maintenance tracking and advisory), linked GPS and particularly tractor and trailer tracking and location. Pass-through outputs may include live data feed (such as via 3G cellular), data and document scanning and transmission. Meaningful differences are readily determined by the analyzer and reported as exceptions for investigation and servicing as appropriate. In an alternate embodiment, the system 120 initiates real-time communications with a selected one of the motor vehicles for receiving motor vehicle operational data as well as video and audio imaging. Such real-time tracking and evaluation may be particularly useful for accident matters as well as other unsafe operational issues.

FIGS. 4A and 4B illustrate in perspective view an embodiment of the sleeve 82 for being received on the headrest 84, with a pair of the straps 92 extending from respective opposing lower edges of the sleeve and distal ends of the straps engaged to mating connectors, for detachably matingly joining the opposing connectors 96, 98 to secure the sleeve 82 to the headrest 84. The housing 100 extends laterally from a side. In this embodiment, at least one video imaging device 22 mounts in a lateral face of the housing 100. The sleeve 82 disposes the imaging device 22 between an upper edge of a driver's seat and an interior surface of a roof of the motor vehicle proximate and lateral of a longitudinal axis of the motor vehicle for imaging in a selected direction that is substantially in alignment with a proximate oriented viewpoint from a driver's seating position within the motor vehicle to generate at least an image proximate the motor vehicle at a time of operation of the imaging device. A recorder (typically included with the imaging camera but may be an independent electronic storage device) stores an electronic representation of the imaging by the imaging device 22. The communications device, upon demand communication from the servicer or manual download selectively undertaken, communicates the stored electronic representation of the imaging to the servicer for monitoring operations of a plurality of the motor vehicles. The recorder in an alternate embodiment is installed, used, and retrieved (including retrieval of stored images and operational information) using evidentiary standards of custody and control.

The connectors 96, 98 join the straps 92, 94 to secure the sleeve 82 to the headrest 84. The straps 92, 94 extend upon a bottom side of the headrest 84. A pair of loops 101 spaced apart on interior opposing sides of the sleeve 82 provide guide channels for holding wiring harnesses for communicating power for a supply connector in the motor vehicle, for connecting the communications device 24 with the antenna 66, and for connecting with the imaging devices 22.

FIG. 4B illustrates an alternate embodiment of the helmet 82 with an elongated housing 100 extending laterally from a side. The video camera or imaging device 22 mounts in the housing 100 proximate a distal end to dispose the imaging device laterally so that the point of view is not blocked (or not blocked significantly) by a portion of a driver's head or attire such as hats, caps, or collar wear such as scarfs. A safety bumper 103 alternatively seats on the distal end of the housing to cushion the driver from contact. The safety bumper may be made of a silicon or other resilient material. The safety bumper 104 defines an opening 106 for the imaging device 22. The safety bumper 104 defines other openings for microphones for receiving sound and audio or for other of the imaging devices 22. In an alternate embodiment, microphones mount on an exterior of the motor vehicle for detecting and transmitting sound to a recording device. Optionally, an MDVR speaker 108 mounts in the housing 100. Opposing the housing 100 is the antenna housing 66 that receives the antenna 66 generally for GPS, cellular and/or wifi signals. Wired connections 108 are received in the helmet 82 for connecting the audio, front and rear facing video cameras 22, the cellular device, speaker, and WiFi cable connections, as well as power connections to the motor vehicle electrical wiring harness. A boot 110 at a bottom perimeter provides a cushioned portion for the helmet relative to driver or passenger head. The boot 110 may contain resilient cushioning materials, silicon, or the like.

With reference to FIG. 4B, a imaging device or camera 22a may mount in opposing relation in the housing 64 or 100 for imaging rearwardly to show rear seat activity and the rear point of view outwardly of a rear window.

Cable loops 101 disposed on inward surfaces provide a cable race for the cables, wires, and other elongated communication carriers and wires of the present apparatus.

With reference to FIGS. 1 and 2, the modular connected headrest 10 installs in the seat 11 for operation of imaging, correlating vehicle operational data, and communicating the images and correlated vehicle operational data to the service center 18 for monitoring of the motor vehicle. The connector 54 feeds through the sleeve 48 and engages the connector 56 of the vehicle wiring harness 58. Optionally, the wiring harness 52 further connects to the vehicle information device such as ODBII and to the navigation device for GPS location services. Optionally, the controller 20 is configured to communicate with the GPS device associated with the vehicle data module 26 in order to correlate location information with the images from the imaging devices 22. The GPS location data may be provided to the controller from a link to the OEM manufacturer installed navigation system or from a standalone GPS device incorporated into the headrest as a functional operating feature. The images/audio from the imaging devices 22, together with vehicle information (speed, direction, acceleration, loading, location GPS coordinates) communicates with the communications device 24 through the network 16 to the service center 18. The service center 18 maintains the database 40 with the vehicle information and evaluates motor vehicle information for reports 42. The vehicle information includes a unique vehicle number, the date and time of the information, the imaged information (video, audio, image), and the motor vehicle operational information.

With reference to FIGS. 4A and 4B, the sleeve 82 readily installs in aftermarket retro-fit applications by seating on and covering the headrest 84. The straps 92, 94 extend underneath the bottom of the headrest and engage together with connectors 96, 98 to secure the sleeve 82 to the headrest. Wiring harness connections provide power and vehicle information to the controller 20.

It is to be appreciated that communication of motor vehicle data may be accomplished with cellular systems, wi-fi, wide area networks, local area networks, or other suitable data communicating systems including Bluetooth, 3 or 4 G cellular.

The apparatus and method of the present invention provides safe and continuous M2M communications connecting the driver and passenger occupants of a motor vehicle with a central stationary remote monitoring complex and system including appropriate information collection and storage equipment configured for receiving, storing, analyzing and reporting on the motor vehicle information. The apparatus system permits driver action monitoring and review, motor vehicle and driver analytics for real-time (instantaneous) or after fact circumstance evaluation and reporting. The apparatus is readily social media connected. The system promotes and facilitates motor vehicle care and servicing, assists with accident and vehicle warranty and operations claims processing by insurers, manufacturers, owners, operators, servicers, and others engaged with the operation, use, maintenance, servicing, ownership, and monitoring of the motor vehicle. Logistics is improved and coordinated for timely response and operation of the motor vehicle. Importantly, accident reconstruction is aided and facilitated by the coordinated compilation of real-time vehicle information coupled with driver point-of-view and vehicle view (selectively, forward, back, sides, 360 degree) imaging.

Target markets appropriate for installation and use of the apparatus and method include business fleet vehicles, trucks, cars, and motor vehicles, commercial transport fleets including local and long distance carriers, bus and transit services, and products and goods transport; youthful drivers, parents, and insurance carriers; driving enthusiast, club driving, or racing participants and facilities service providers; tourists including sight seers and vacationers; social media postings and blogs of recorded imagery.

The application of the present integrated system of imaging, correlating real-time motor vehicle information, and communicating for memorialization though a headrest of a motor vehicle facilitates near center-line driver view imaging providing a reasonable overall picture of the interior and the roadway, while integrating a package of connectivity devices for the operational features. Headrests, due to safety issues, are generally similar in size and shape, and with standardized support posts may interchange readily, and in the alternate embodiment, configure with the aftermarket retro-fit sleeve that readily connects for power, information acquisition for correlation, and for communication. The headrest, behind the driver, lends itself as a safe location of the equipment, and facilitates ease of installation. Specialized equipment, while suitable as special design for the application, may not be necessary as off-the-shelf components may be readily obtained and configured for safe installation within the headrest volume.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The microprocessor controlled modular headrest imaging apparatus and method can be a component of a single system, multiple systems, and/or geographically separate systems. The modular headrest imaging apparatus and method can also be a subcomponent or subsystem of a single system, multiple systems, and/or geographically separate systems. The modular headrest imaging components can be coupled to one or more other components (not shown) of a host system or a system coupled to the host system.

One or more components of the modular headrest imaging apparatus and method and/or a corresponding interface, system or application to which the modular headrest imaging apparatus is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistant devices, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the modular headrest imaging apparatus and method can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include but are not limited to, removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the modular headrest imaging apparatus and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the modular headrest imaging apparatus and method and corresponding systems and methods include: microcontrollers with memory (such as electronically erasable programmable read only memory (EEPROM)), embedded microprocessors, firmware, software, etc. Furthermore, aspects of the modular headrest imaging apparatus and method and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the modular headrest imaging apparatus and method and the corresponding systems and methods is not intended to be exhaustive or to limit the systems and methods to the precise forms disclosed. While specific embodiments of, and examples for, the modular headrest imaging apparatus and method and corresponding systems and methods are described herein for illustrative purposes, various equivalent modifications are possible within the scope of the systems and methods, as those skilled in the relevant art will recognize. The teachings of the modular headrest imaging apparatus and method and corresponding systems and methods provided herein can be applied to other systems and methods, not only for the systems and methods described above.

The various embodiments described above can be combined and modified to provide further embodiments. These and other changes can be made to the modular headrest imaging apparatus and methods and corresponding systems and methods in light of the above detailed description. While this invention has been described in detail with particular reference to illustrative, non-limiting embodiments thereof, the principles and modes of operation of the present invention have been described in the foregoing specification. The invention is not to be construed as limited to the particular forms disclosed because these are regarded as illustrative rather than restrictive. Moreover, those skilled in the art may make modifications, variations and changes thereto without departure from the spirit and scope of the invention as described by the following claims.

What is claimed is:

1. A motor vehicle usage tracking system, comprising:
a servicer configured for monitoring operations of a plurality of motor vehicles that are each equipped with a data bus that periodically receives one or more signals representative of motor vehicle operational data, the data bus including a timer for associating the motor vehicle operational data with a time of occurrence and a bi-directional communications device, for tracking usage and situational circumstances of the motor vehicle operations, evaluating motor vehicle operations, and reporting on motor vehicle operations;
a communications device operatively engaged to a communications network and to the servicer for communicating between the servicer and a respective communications device of the plurality of motor vehicles;
a geophysical locating device for determining periodically a location of the geophysical locating device and an associated time thereof and configured for communicating the determined location and associated time to the data bus of the motor vehicle;
a plurality of modular headrests, each for being installed in a respective one of the plurality of motor vehicles and containing;
at least one imaging device mounted therein for being disposed between an upper edge of a driver's seat and an interior surface of a roof of the motor vehicle proximate and lateral of a longitudinal axis of the motor vehicle for imaging in a selected direction that is substantially in alignment with a proximate oriented viewpoint from a driver's seating position within the motor vehicle to generate at least an image proximate the motor vehicle at a time of operation of the imaging device, and
a controller for connecting to the data bus of the motor vehicle for receiving the operational data thereof and the associated time and configured for correlating the imaging with the motor vehicle operational information; and
the respective communications device of the motor vehicle for communicating the periodic location and time and correlated operational data to the servicer, and upon demand, communicating at least a portion of the imaging generated by the imaging device.

2. The motor vehicle usage tracking system as recited in claim 1, wherein the controller comprises a microprocessor.

3. The motor vehicle usage tracking system as recited in claim 1, wherein the modular headrest comprises a forwardly viewing imager, a laterally viewing imager, and a rearwardly viewing imager, each communicating with the controller, for imaging proximate the driver's seating position in a forward direction, a lateral direction, and a rearward direction, respectively.

4. The motor vehicle usage tracking system as recited in claim 1, wherein the controller communicates with the servicer for collection of operational data, images, and associate time, for update maintaining in an electronic memory recorder in a motor vehicle information collecting system.

5. The motor vehicle usage tracking system as recited in claim 1, further comprising a supply of power for operating the at least one imaging device and the controller of the modular headrest.

6. The motor vehicle usage tracking system as recited in claim 1, further comprising a supplemental battery backup for continued operation of the at least one imaging device and the controller of the modular headrest.

7. The motor vehicle usage tracking system as recited in claim 1, further comprising a data base for collecting motor vehicle operational data, images and associated times; and an analyzer configured for generating analysis reports of motor vehicle operation based on the collected motor vehicle operational data, images and associated times.

8. The motor vehicle usage tracking system as recited in claim 1, wherein the modular headrest comprises an OEM headrest and a sleeve comprising a back, a front, and opposing sides open at a first end, with a housing extending from one of the opposing sides and the imaging device mounted therein, for aftermarket retro-fit installation in a motor vehicle.

9. The motor vehicle usage tracking system as recited in claim 8, further comprising fasteners for securing the sleeve to the OEM headrest.

10. The motor vehicle usage tracking system as recited in claim 9, wherein the fasteners comprise a strapping and connector buckles for detachably securing the sleeve to the OEM headrest.

11. The motor vehicle usage tracking system as recited in claim 1, wherein each modular headrest further comprises an audio imaging device for recording sound signals received thereat.

12. The motor vehicle usage tracking system as recited in claim 1, further comprising a wireless transceiver; and wherein each modular headrest further comprises an antenna array for receiving and transmitting signals with the wireless transceiver, whereby the wireless transceiver, being worn by a driver outside of the motor vehicle, communicates sound signals between the controller and the wireless transceiver.

13. The motor vehicle usage tracking system as recited in claim 1, further comprising an analyzer configured for monitoring received operational data communicated from a respective one of the plurality of motor vehicles and reporting on an evaluated occurrence represented by the operational data as an anomaly for a responsive engagement with the operator of the motor vehicle.

14. The motor vehicle usage tracking system as recited in claim 1, wherein the data bus receives motor vehicle operational data from the group comprising audio/video imaging signals from the imagers, accelerometer data, GPS (location), RF tag log signals, event triggers (including speed, deceleration, alarm, and air bag), geofencing signals for tracking restricted or permissive locations, vehicle maintenance (mileage, oil pressure and quality, coolant temperature and life status, CAN bus, and OBDII data.

15. The motor vehicle usage tracking system as recited in claim 14, wherein an analyzer configured for evaluating and responding to event triggers.

16. The motor vehicle usage tracking system as recited in claim 1, wherein an analyzer is configured for a geofencing determination for tracking restricted or permissive locations of a respective one of the plurality of motor vehicles.

17. The motor vehicle usage tracking system as recited in claim 1, wherein an analyzer is configured for evaluating motor vehicle operational data and determining for a respective one o of the motor vehicles a variance from a predetermined standard for reporting in order to take action in response thereto.

18. The motor vehicle usage tracking system as recited in claim 17, wherein the predetermined standard is selected from the group comprising mileage (accumulated and trip-based), routing, lane departure indication signals, trip recording, motor vehicle performance (fuel usage, maintenance tracking), location and time, differential location and time. trailer tracking and location reporting).

19. The motor vehicle usage tracking system as recited in claim 1, further comprising real-time access to the imaging of the imaging device.

20. The motor vehicle usage tracking system as recited in claim 1, further comprising an accident reconstruction system that receives a selected portion of motor vehicle operational data, imaging, and associate times for a selected one of the plurality of motor vehicles for accident analysis.

21. An aftermarket motor vehicle usage tracking device, comprising:
a sleeve having a back, a front, and opposing sides open at a first end, with a housing extending from one of the opposing sides, the sleeve sized for aftermarket retro-fit installation by being slidably received on a headrest of a motor vehicle;
at least one imaging device mounted in a wall of the housing, to dispose the imaging device between an upper edge of a driver's seat and an interior surface of a roof of the motor vehicle proximate and lateral of a longitudinal axis of the motor vehicle for imaging in a selected direction that is substantially in alignment with a proximate oriented viewpoint from a driver's seating position within the motor vehicle to generate at least an image proximate the motor vehicle at a time of operation of the imaging device;
a recorder for storing an electronic representation of the imaging by the imaging device; and
means for communicating the stored electronic representation of the imaging to a servicer configured for monitoring operations of a plurality of motor vehicles.

22. The aftermarket motor vehicle usage tracking device as recited in claim 21, further comprising:
a controller for connecting to a data bus of the motor vehicle that periodically receives one or more signals representative of motor vehicle operational data, the data bus including a timer for associating the motor vehicle operational data with a time of occurrence, to receive signals representative of the operation of the motor vehicle and to associate a time therewith and configured for correlating the imaging by the image device with the motor vehicle operational data for recording in the recorder the motor vehicle operational data, imaging and associated time; and
wherein the means for communicating communicates the recorded motor vehicle operational data and associated time.

23. The aftermarket motor vehicle usage tracking device as recited in claim 22, further comprising means for securing the sleeve to the headrest.

24. The aftermarket motor vehicle usage tracking device as recited in claim 23, wherein means for securing comprises a pair of straps attached at respective first ends to opposing sides of the sleeve and a mating connector attached to a respective distal end of the straps, the mating connectors for matingly detachably joining together for selective engagement and removal of the sleeve.

25. The aftermarket motor vehicle usage tracking device as recited in claim 21, further comprising a connection to a supply of power for operating the imaging device.

26. The aftermarket motor vehicle usage tracking device as recited in claim 25, wherein the supply of power comprises a battery held within the sleeve.

27. The aftermarket motor vehicle usage tracking device as recited in claim 21, further comprising a transceiver for communicating imaging of the image device in real time to a servicer configured for monitoring operations of a plurality of motor vehicles.
